(19) United States
(12) Patent Application Publication
(10) Pub. No.: US 2004/0045018 A1
(43) Pub. Date: Mar. 4, 2004

(54) Using address space bridge in postoptimizer to route indirect calls at runtime

(76) Inventor: Sreekumar R. Nair, Sunnyvale, CA (US)

Correspondence Address: HAMILTON & TERRILE, LLP, P.O. BOX 203518, AUSTIN, TX, 78720, US

(21) Appl. No.: 10/228,431

(22) Filed: Aug. 27, 2002

(51) Int. Cl. G06F 9/00

(52) U.S. Cl. 719/331

(57) ABSTRACT

A method for optimizing an object file is described. The method includes simulating execution of an object file, where the object file includes a control transfer instruction having an undefined target, and modifying the object file to include an address space bridge section, where the address space bridge section is configured to define the undefined target. When the newly optimized object file is executed, the address space bridge is invoked and the target is mapped in memory in an original address space.

### BACKGROUND OF THE INVENTION

1. Field of the Invention

The present invention relates generally to software compilation and optimization, and, more particularly, to a system and method of optimizing software that includes control transfer instructions.

2. Description of the Related Art

In most cases, programmers write computer applications in high level languages, such as JAVA™ and/or C++, and rely on sophisticated optimizing compilers and/or link time optimizers to convert the high-level code into an efficient executable computer program. Compiler and post-compiler optimizers have replaced the time consuming task of handcoding applications in low level assembly or machine-code for improved efficiency. An optimizer typically performs transformations on the code to improve execution times and utilize computer resources more efficiently. A link-time optimizer, e.g., a postoptimizer, typically optimizes relocatable object files during link time to improve performance of large scale applications.

Some of the code transformations done by an optimizer or postoptimizer are based on the structure of the code, and cannot be related to the target processor used for execution. Other types of transformations can improve the code by utilizing specific features associated with the target processor such as registers, pipeline structures and other hardware features.

A postoptimizer typically generates an optimized relocatable object file from one or more input relocatable object files. The postoptimizer disassembles the contents of the text sections of the input relocatable object file and composes an internal whole program control flow graph. The control flow graph is then transformed based on various optimization algorithms. After performing the optimizations, the control flow graph is converted into one or more executable and linking format (“ELF”) file sections in an optimized relocatable object file.

The typical strategy to disassemble the contents of a text section of an input object file involves the use of a dataflow technique called partial evaluation of programs, also known as static simulation. Generally, static simulation involves simulating a program's execution in order to construct a control flow graph. However, the presence of indirect branches within the input object file provides a challenge to static simulation, and thus optimization.

While static simulation can detect and optimize many identified indirect branches, there can be instances where the simulation will fail, or worse, continue and produce unexpected results when the targets of indirect branches are hidden, i.e. not locatable during the static simulation. What is therefore needed is a technique to determine the targets of hidden control transfer instructions within an optimized program and efficiently provide these targets in memory for the execution of the optimized program.

### SUMMARY OF THE INVENTION

By providing an address space bridge according to the present invention, programs which before could not be optimized because, for example, a code routine within the program contained a branch instruction having an undefined target, can now be optimized and executed accordingly.

Thus, in accordance with the present invention, a method for optimizing an object file is disclosed. The method includes simulating execution of an object file, where the object file includes a control transfer instruction having an undefined target, and modifying the object file to include an address space bridge section, where the address space bridge section is configured to define the undefined target.

In another embodiment of the present invention, a compiler for optimizing an object file is disclosed. The compiler includes a module to simulate execution of the object file, where the object file includes a control transfer instruction having an undefined target, and a module to modify the object file to include an address space bridge section, where the address space bridge section is configured to define the undefined target.

The foregoing is a summary and thus contains, by necessity, simplifications, generalizations and omissions of detail; consequently, those skilled in the art will appreciate that the summary is illustrative only and is not intended to be in any way limiting. As will also be apparent to one of skill in the art, the operations disclosed herein can be implemented in a number of ways, and such changes and modifications can be made without departing from this invention and its broader aspects. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features and advantages made apparent to those skilled in the art by referencing the accompanying drawings. The use of the same reference number throughout the figures designates a like or similar element.

FIG. 1 is a block diagram illustrating a compiler according to an embodiment of the present invention.

FIG. 2 is a block diagram illustrating a post optimizer according to an embodiment of the present invention.

FIG. 3 illustrates an object file for use with an embodiment of the present invention.

FIG. 4A is a flow diagram illustrating a process for providing a control flow graph according to an embodiment of the present invention.

FIG. 4B is a flow diagram illustrating a process for providing an address space bridge according to an embodiment of the present invention.

FIG. 5A and FIG. 5B illustrate exemplary address space bridge sections according to an embodiment of the present invention.

FIG. 6 is a block diagram illustrating a memory containing optimized code with an address space bridge according to an embodiment of the present invention.

FIG. 7 is a flow diagram illustrating the runtime initialization of an address space bridge according to an embodiment of the present invention.

FIG. 8 is a computer for use in optimizing and executing a program according to an embodiment of the present invention.

While the invention is susceptible to various modifications and alternative forms, specific embodiments thereof are shown by way of example in the drawings and will herein be described in detail. However, the drawings and detailed description thereto are not intended to limit the invention to the particular form disclosed. On the contrary, the intention is to cover all modifications, equivalents, and alternatives falling within the spirit and scope of the present invention as defined by the appended claims.

### DETAILED DESCRIPTION

Traditional methods of optimization rely on the optimization of all instructions within an object file or set of object files. However, optimization and correct execution of all of the instructions is not possible if the object file includes a control transfer function having an undefined branch target, for example a target which is not known at the time of optimization. Consequently, such object files are not optimized. Embodiments of the present invention, however, modify an optimized object file to include only necessary code which defines the undefined branch target of a control transfer function within the optimized object file.

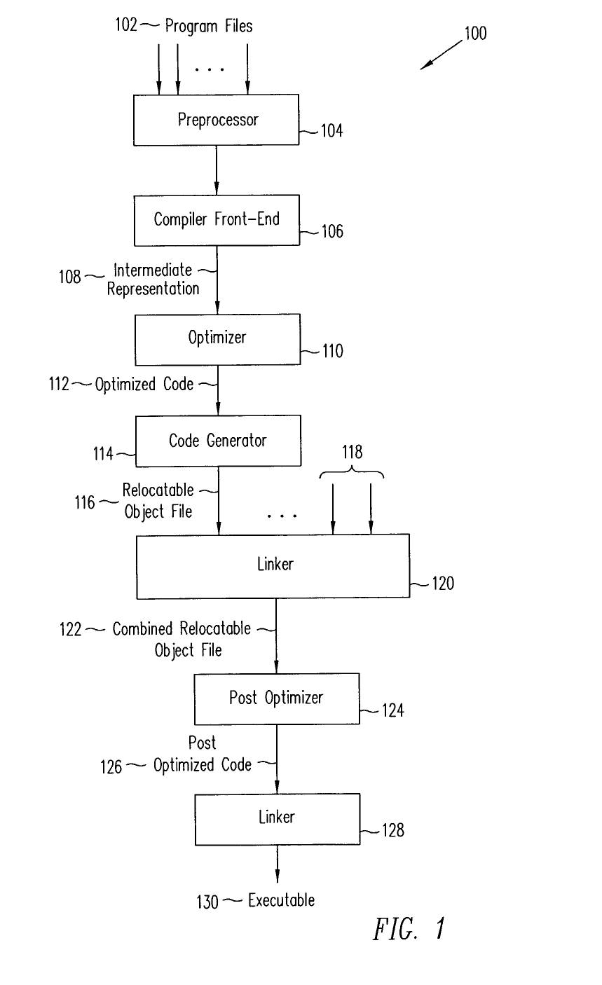

FIG. 1 illustrates a block diagram of a compiler 100 for use in generating optimized executable code according to an embodiment of the present invention.

To generate optimized executable code using compiler 100, one or more program files 102 are input into a preprocessor 104. Preprocessor 104 performs such tasks as, for example, replacing certain names in program files 102 with token strings (e.g., #define) and/or carrying out directives included in program files 102 (e.g., including one or more header files as directed by #include).

The output from preprocessor 104 is input into a compiler font-end 106. Compiler front-end 106 translates the instructions in program files 102 into assembly language instructions to produce an intermediate representation 108.

From compiler font-end 106, intermediate representation 108 is input into an optimizer 110 to produce optimized code 112, which in turn is input into a code generator 114 to produce a relocatable object file 116. In one embodiment of the present invention, code generator 114 generates code which is part of the SPARC™ V9 instruction set architecture. In another embodiment of the present invention, code generator 114 generates code which is part of an Intel based instruction set architecture.

Relocatable object file 116 is input into a linker 120 along with additional relocatable object files 118. Linker 120 links relocatable object file 116 with additional relocatable object files 118, and any necessary library functions, to produce combined relocatable object file 122.

From linker 120, combined relocatable object file 122 is input into a post-optimizer 124 to produce post-optimized code 126. Post-optimizer 124 is a link-time optimizer which generates optimized relocatable object files from one or more input relocatable object files. Post-optimizer 124 generates post-optimized relocatable object files by disassembling the input relocatable object file, composing an internal whole program control flow graph, optimizing the control flow graph, and generating a post-optimized relocatable object file from the optimized control graph. From post-optimizer 124, post-optimized code 126 is input into linker 128 to produce optimized executable 130.

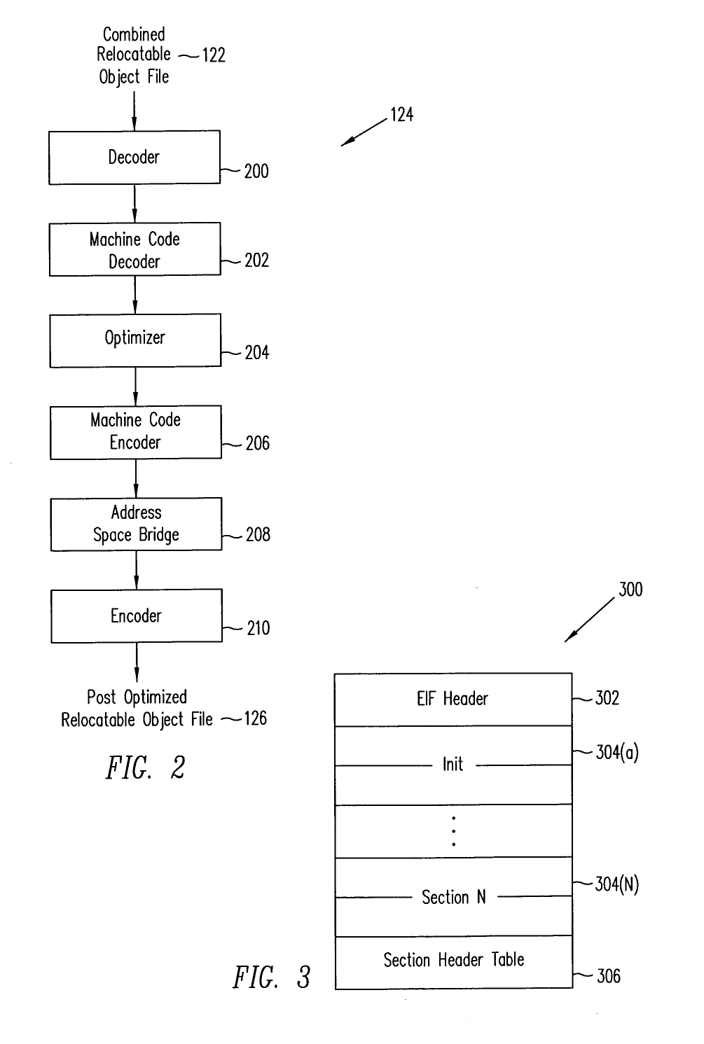

FIG. 2 is a block diagram illustrating post-optimizer 124 according to an embodiment of the present invention, in greater detail. Combined relocatable object file 122 is input into a decoder 200. Decoder 200 decodes combined relocatable object file 122 into one or more text sections containing executable code. In one embodiment of the present invention, decoder 200 is an executable and linking format (ELF) decoder. In another embodiment of the present invention, decoder 200 is a decoder which can decode multiple object file formats in addition to ELF files.

The output from decoder 200 is input into a machine code decoder 202. Machine code decoder 202 reads and disassembles binary instructions of combined relocatable object file 122 into an internal representation for use by post-optimizer 124. When a control flow instruction (e.g., a branch instruction) is identified during disassembly, disassembly continues recursively through to the branch target. If the branch is an indirect branch, then one process to identify the branch target during this disassembly involves a dataflow technique called static simulation of programs, as described in U.S. patent application Ser. No. 09/679,945 filed Oct. 4, 2000, entitled “USING VALUE-EXPRESSION GRAPHS FOR DATA-FLOW OPTIMIZATIONS”, which is incorporated by reference herein in its entirety. The overall disassembly process continues until all functions within combined relocatable object file 122 have been disassembled.

The output of machine code decoder 202 is essentially a control flow graph representation of combined relocatable object file 122, which is in turn, optimized by an optimizer 204. After optimization, a machine code encoder 206 encodes the optimized control flow graph representation into machine specific binary instructions.

As mentioned above, the disassembly of combined relocatable object file 122 involves a dataflow technique called static simulation of programs. However, there are certain circumstances for which static simulation is not able to identify the target of the control flow instruction (e.g., the program contains an indirect branch instruction for which the target is not identifiable during static simulation). In these circumstances, the services of an address space bridge according to the present invention can be generated and utilized to define the branch target. As described in greater detail with reference to the figures below, address space bridge 208 provides for correct execution of such indirect branches.

After having provided the necessary address space bridge, an encoder 210 encodes the binary instructions into post-optimized relocatable object file 126. In one embodiment of the present invention, encoder 210 is an executable and linking format (ELF) encoder. In another embodiment of the present invention, encoder 210 is an encoder which can encode multiple object file formats in addition to ELF files.

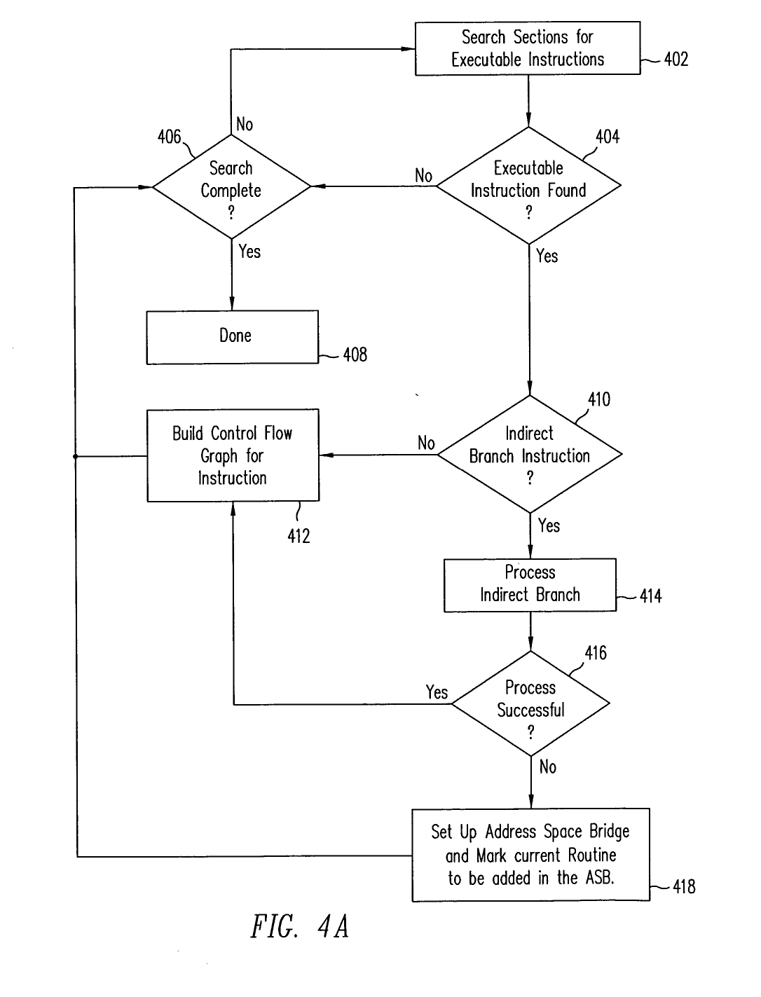

FIG. 3 illustrates an object file 300 for use with an embodiment of the present invention. For example, object file 300 can be optimized by post-optimizer 124. Although object file 300 is illustrated as an ELF file, COFF, ECOFF, XCOFF, PE, SOM, and/or other object file formats can be used.

An ELF header 302 resides at the beginning of object file 300 and provides a map that describes the overall organization of object file 300. ELF header 302 includes such information as object file type and version, file offsets, section size and location information.

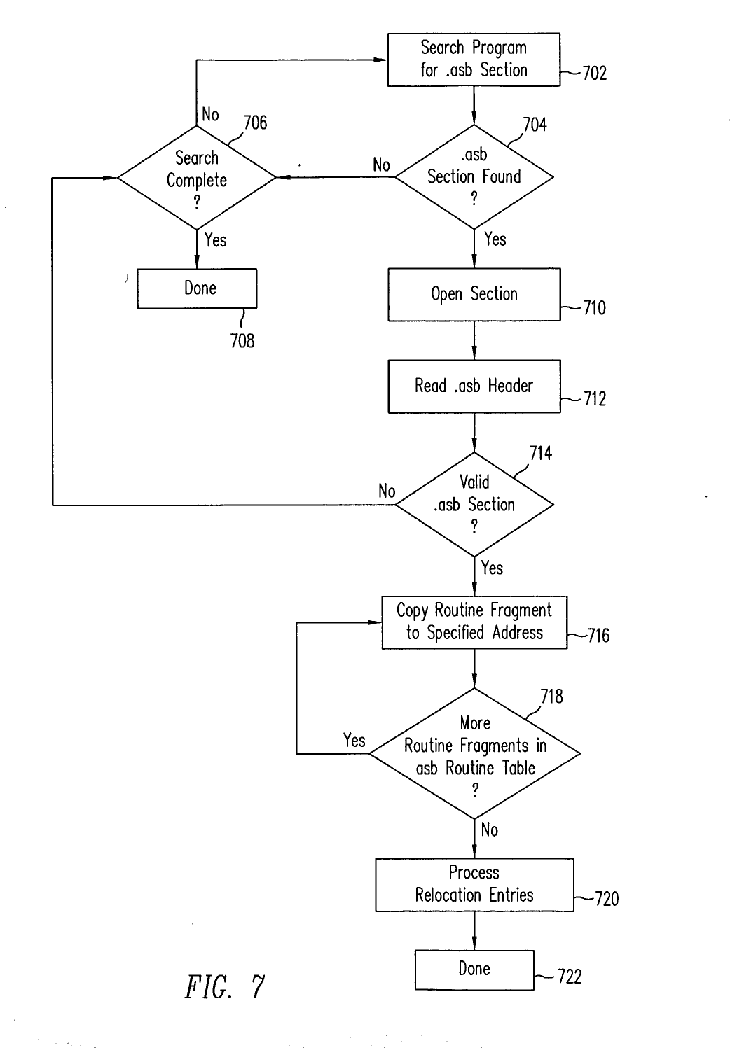

Object file 300 also contains one or more sections 304. Sections 304 contain all of the information in object file 300 not contained in ELF header 302, a section header table 306, and a program header table (not shown). For example, section 304 includes an “.init” section 304(a) which includes executable instructions for the runtime initialization of program 300. When object file 300 is run, a system (e.g., system 700 of FIG. 7) begins executing code in “.init” section 304(a) before calling the main entry point (e.g., the function “main” in the case of a C program). Located at the end of object file 300 is a section header table 306 which provides information necessary to locate sections 304.

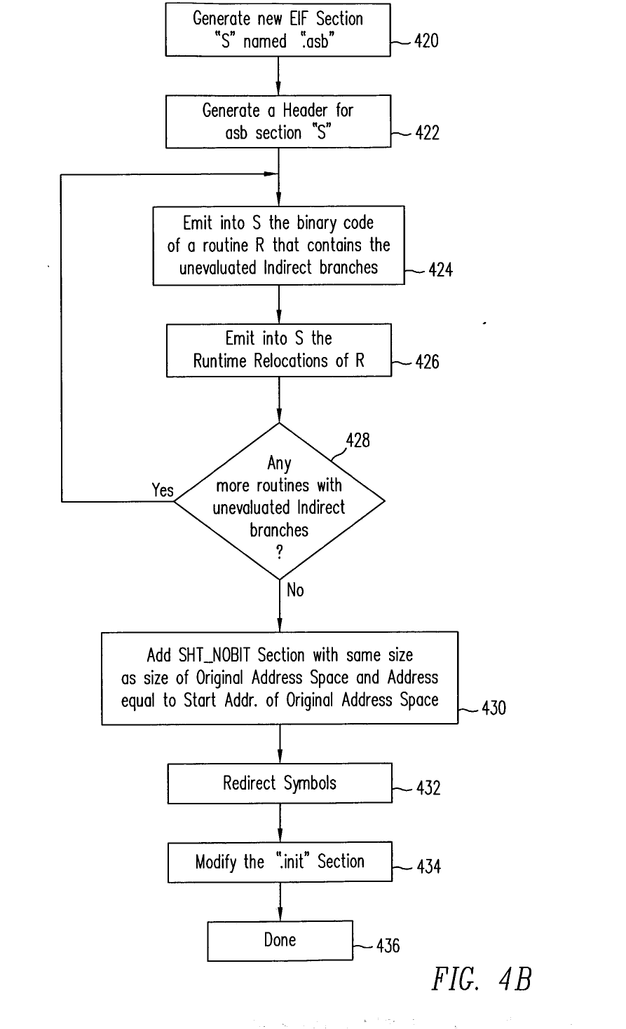

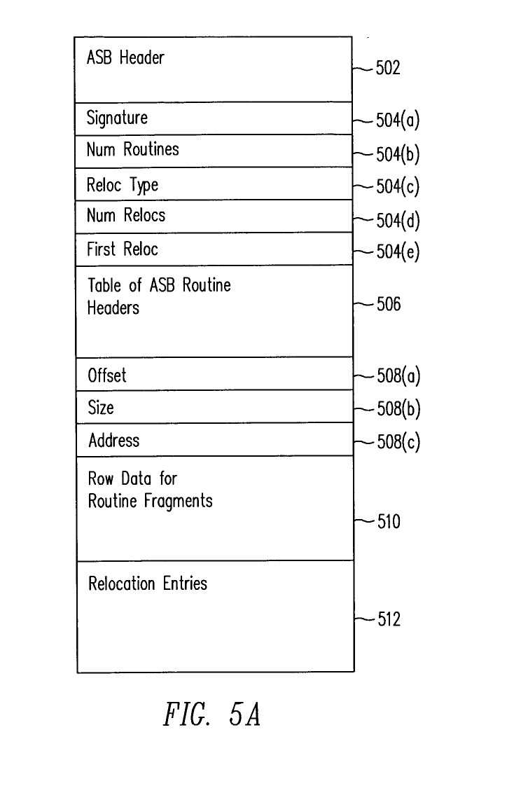

FIGS. 4A and 4B are flow diagrams illustrating the overall flow of optimizing one or more object files according to an embodiment of the present invention. FIG. 4A illustrates generally, the actions taken to optimize one or more object files according to an embodiment of the present invention. Initially, a section of the object file (e.g., a section 304 of object file 300 in FIG. 3) is searched for executable instructions (step 402).

If an executable instruction is not located within the section, control is passed (“No” branch of decision block 404) to determine if there are additional sections to search (decision block 406). If there are no additional sections to search, the process is complete (step 408). However, if there are additional sections to search, control is passed (“No” branch of decision block 406) to search for executable instructions (step 402). If an executable instruction is located within a section, control is passed (“Yes” branch of decision block 404) to determine if the executable instruction is an indirect branch instruction (decision block 410).

If the executable instruction is not an indirect branch instruction, control is passed (“No” branch of decision block 410) to build a control flow graph for optimizing the executable instruction (e.g., as described in the above referenced U.S. patent application Ser. No. 09/679,945, entitled “USING VALUE-EXPRESSION GRAPHS FOR DATA-FLOW OPTIMIZATIONS”) (step 412). Once the control flow graph is complete, control is passed to determine if there are additional sections to search (decision block 406).

If the executable instruction found in the section is an indirect branch instruction, control is passed (“Yes” branch of decision block 410) to process the indirect branch (e.g., as described in as described in U.S. patent application Ser. No. 09/679,945, entitled “USING VALUE-EXPRESSION GRAPHS FOR DATA-FLOW OPTIMIZATIONS”) in order to determine the target address of the indirect branch (step 414). If the process is successful (e.g., the target address of the indirect branch can be identified), control is passed (“Yes” branch of decision block 416) to build the control flow graph for the target instructions (step 412).

If, however, the processing of the indirect branch is not successful (i.e., the target address is not identifiable), then control is passed (“No” branch of decision block 416) to generate an address space bridge and mark the current routine for addition to the ASB section (step 418). Upon completion of step 418, the search for executable instructions in the sections of the object file continues with control passing to decision block 406.

FIG. 4B illustrates generally the actions taken to provide an address space bridge according to an embodiment of the present invention. Initially in step 420, an address space bridge (“.asb”) section is added to the object file undergoing optimization. The object file can be, for example, combined relocatable object file 122 of FIG. 1 in the format shown in FIG. 3. The “.asb” section contains information relating to the number and location of indirect branches that are identified in the object file. A header for the “.asb” section is then generated (step 422).

Following the generation of the “.asb” section, the binary code of routine R that contains the unevaluated indirect branch is emitted into segment S (step 424) followed by any necessary runtime relocations which must be performed (step 426). In decision block 428, a decision is made as to whether or not there are any more routines with unevaluated indirect branches to be copied into the “.asb” section. If there are, the code fragments (routines) are provided in the “.asb” section along with any runtime relocations. If, however, all of the code fragments (routines) have been provided in the “.asb” section, and there are no more routines with unevaluated indirect branches to be processed, a size adjustment is made to the object file by adding a section of type SHT_NOBITS (step 430). A section of type SHT_NOBITS is an ELF section which occupies no space in the object file. However, the section does contain an offset member as if the object file contained a given number of bytes. The size of the SHT_NOBITS section is set to the same size and address as the unoptimized object file (the object file optimization by post-optimizer 124). Next, any symbols of the post-optimized object file which must be redirected are redirected (step 432).

In step 434, the “.init” section is modified to include a call to a routine that sets up the address space bridge during program initialization. As described above with reference to FIG. 3, a “.init” section contains executable instructions for the runtime initialization of the object file. When the program begins to run, the program executes the code in the “.init” section. The addition of the call to the address space bridge setup routine in the “.init” section completes the initialization of the original address space prior to transferring control to the main entry point in the program (step 436).

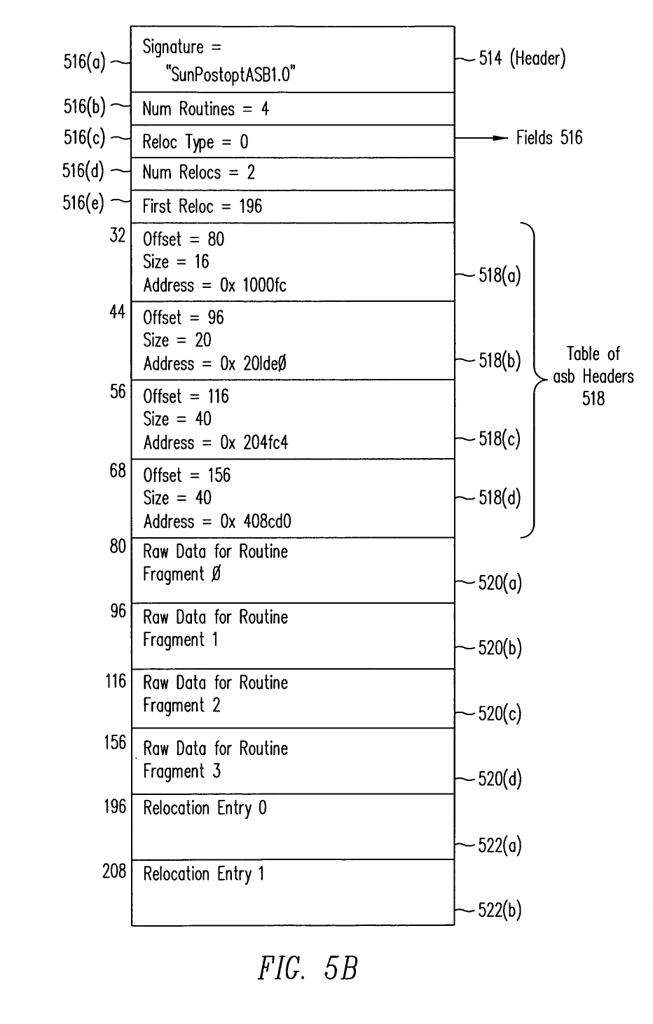

FIG. 5 illustrates an exemplary “.asb” section according to an embodiment of the present invention. The “.asb” section of FIG. 5A includes an ASB header 502 with fields 504, a table of ASBRoutine headers 506 with fields 508, raw data for routine fragments 510, and relocation entries 512.

ASB header 502 is the header for the “.asb” section and includes fields 504. Signature field 504(a) includes information to identify the “.asb” section as a valid “.asb” section. NuniRoutines field 504(b) includes the number of routine fragments in the “.asb” section. RelocType field 504(c) indicates the bit-size of the relocation entries (e.g., 32 bits or 64 bits). NumRelocs field 504(d) includes the number of relocation entries in the “.asb” section. FirstReloc field 504(e) includes the section relative offset of the beginning of the relocation entries.

Table of ASB routine headers 506 with fields 508 contains the header information for each of routine fragments 510 within the “.asb” section. For each routine fragment 510 in the “.asb” section, there is provided an offset field 508(a), a size field 508(b), and an address field 508(c). Offset field 508(a) contains the section relative offset of the beginning of the relocation entries. Size field 508(b) contains the size in bytes of the raw data of the routine fragment. Address field 508(c) contains the virtual address where the routine fragment is to be mapped. Raw data for the routine fragments is stored in area 510, while the relocation entries are stored in area 512. In one embodiment of the present invention, raw data 510 is stored in a compressed format, decreasing the overall size of the optimized program.

FIG. 5B illustrates an exemplary “.asb” section according an embodiment of the present invention. Included in the “.asb” section of FIG. 5B is ASB Header 514 including fields 516, Table of ASBRoutine headers 518, raw data for routine fragments 520, and relocation entries 522.

ASB Header 514, beginning at offset 0, includes fields 516 which provide an overall map of the “.asb” section. Signature field 516(a) includes the signature “SunPostoptASB1.0” to indicate that the “.asb” section is a valid “.asb” section. NumRoutines field 516(b) indicates there are four routine fragments in the “.asb” section. RelocType field 516(c) contains a “0” which indicates that the bit-size of the relocation entries is 32 bits (other values can be used to identify the bit-size). Numrelocs field 516(d) indicates there are two relocation entries, with the first one at offset 196, as indicated by FirstReloc field 516(e).

Table of ASBRoutine headers 518 provides information describing the offset, size, and address of raw data 520 for the routine fragments in the “.asb” section. For example, ASBRoutine header 518(a) begins at offset 32 within the “.asb” section and contains information describing the offset, size and address of raw data for routine fragment 520(a). As indicated in ASBRoutine header 518(a), the raw data for routine fragment 0 begins at offset 80 within the “.asb” section, is 16 bytes in size, and is to be mapped at virtual address 0x1000fc. ASBRoutine headers 518(b)-(d) contain similar information for routine fragments 520(b)-(d), respectively. The “.asb” section of FIG. 5B also includes relocation entries 522 which include information to be relocated. In one embodiment of the present invention, raw data for routine fragments 520(a)-(d) are stored in a compressed format, decreasing the size of the “.asb” section and also the overall size of an object file including the “.asb” section.

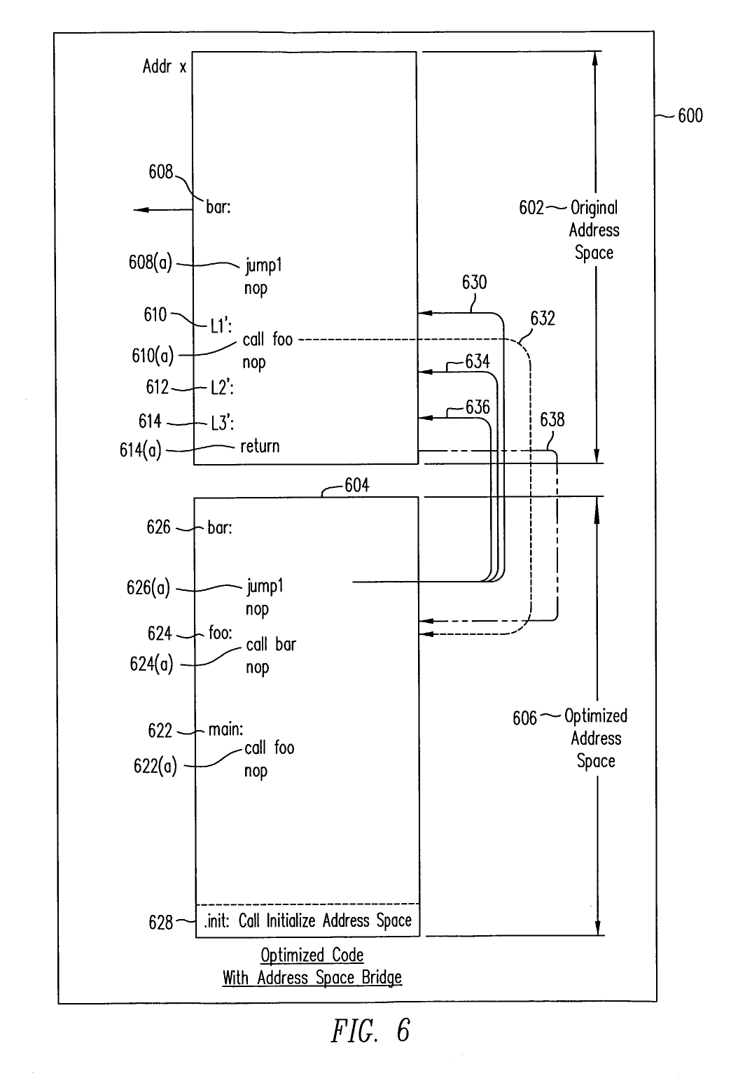

FIG. 6 is a diagram illustrating memory containing optimized code with an address space bridge according to an embodiment of the present invention. The address space bridge provides a target for control flow transfer instructions included in the optimized program.

A memory 600 includes an original address space 602, and an optimized program 604 mapped in an optimized address space 606. Original address space 602 includes a bar routine 608 having an indirect branch instruction 608(a). Original address space 602 further includes L1 label 610 having call instruction 610(a), L2 label 612, and L3 label 614 having return instruction 614(a).

Optimized program 604 in optimized address space 606 includes main routine 622 having a call instruction 622(a). Optimized program 604 also includes a foo( ) routine 624 having a call instruction 624(a), and a bar routine 626 having an indirect branch instruction 626(a), and “.init” section 628. Optimized program 604 is produced, for example, by post-optimizer 124.

Post-optimizer 124 builds an operands graph of a program's code. The operands graph is a unique representation of the program's code and is constructed by modeling the program's control flow instructions. In general, control flow instructions are instructions which transfer control within the program (e.g., branch instructions). Beginning with an entry point in the program, an operands graph of a code routine within the program is constructed until a control flow instruction is detected. The target of the control flow instruction is simulated and the operands graph is modified to take into account the target code of the control flow instruction. This process of simulating code and following the control flow of instructions within a program continues until a operands graph has been completed for the whole program.

However, not all program control flow instructions can be successfully modeled with this process. For example, in programs which include indirect branch instructions having undefined target addresses, the target routine containing the target branch cannot be determined during the construction of the operands graph, and thus the program cannot be optimized accordingly. Further, without being able to successfully model all instructions within the program, the program as a whole cannot be optimized. To accommodate this situation, embodiments of the present invention are used to provide an address space bridge to allow the optimized code to correctly handle the runtime processing of indirect branches which can occur from the optimized code.

The address space bridge provides for the processing of an indirect branch instruction within an optimized program by providing a version of the target routine within memory to which the indirect branch can branch. Upon completion of the routine within the un-optimized code (e.g., a return statement is encountered), program flow continues within the optimized code.

A description of the program flow of bar routine 626 is now described to provide an example of how the address space bridge provides for processing of indirect branch 626(a). For the purpose of describing the program flow, it is assumed that indirect branch instruction 626(a) is taken based on the conditions of a “switch” statement within bar routine 626, although indirect branch instruction 626(a) can be part of any number of code segments, for example a code segment which indirectly branches based on a value read from a file at runtime.

In one case statement of the switch statement, indirect branch instruction 626(a) in optimized address space 606 branches to L1 label 610. Upon taking this branch, control is redirected to L1 label 610 and the code associated with L1 label 610 is executed within original address space 602. As shown in FIG. 6, L1 label 610 includes a call to foo( ) 610(a). Since foo( ) is an optimized routine, control passes to foo( ) routine 624 within optimized address space 606. The code associated with foo( ) routine 624 is executed within optimized address space 606 and, when complete, is transferred back to L1 label 610 in original address space 606. When execution of code within L1 label 610 is complete, execution resumes within bar routine 626 in optimized address space 606.

Thus, by providing an address space bridge, programs which before could not be optimized because a code routine within the program contained an undefined branch target, can now be optimized and correctly executed by providing an original execution space to which the branch instructions can branch. To provide the address space bridge in memory 600 when optimized program 604 is executed, the “init” section 628 of optimized program 604 includes a call to a routine, InitializeAddressSpaceBridge (not shown), which initializes the address space bridge in accordance with embodiments of the present invention as described subsequently with reference to FIG. 7.

FIG. 7 is a flow diagram illustrating how an address bridge according to an embodiment of the present invention can be provided in memory (e.g., original address space 602, and optimized address space 606). Generally, as described with reference to FIG. 3, when an ELF type object program is first executed, execution begins within a “.init” section of the program. Further, as described with reference to FIG. 6, optimized program 604 includes “.init” section 628 which further includes a call to a routine, InitializeAddressSpaceBridge, which is responsible for initializing the address space bridge. Thus, when optimized program 604 is first executed, code within “.init” section 628 is first executed, and a branch to InitializeAddressSpaceBridge is taken which carries out the actions shown in FIG. 7.

Initialization of the address space bridge begins by searching optimized program 604 for an “.asb” (e.g., an “.asb” similar to FIG. 5A) (step 702). If no “.asb” section is found (“No” branch of decision block 704), and the search is complete (“Yes” branch of decision block 706), the initialization is complete (step 708). If, however, the search is not complete, the search for a “.asb” section resumes (“No” branch of decision block 706 and step 702).

If an “.asb” section is found (“Yes” branch of decision block 704), the section is opened (step 710) and the header is read (step 712) to determine if the located “.asb” section is a valid “.asb” section (step 714). If the “.asb” section is not a valid “.asb” section, the search for additional “.asb” sections resumes with decision block 706 (“No” branch of decision block 714). If, however, the “.asb” section is a valid “.asb” section (“Yes” branch of decision block 714), control continues to (step 716).

In step 716, the routine fragments which contain the hidden indirect branch instructions (identified by, e.g., 518(a) of FIG. 5) are copied into original address space 602. Because it is not necessary to copy all the routine fragments of the original program into original address space 602, but only required routine fragments (e.g., those routine fragments in the “.asb” section), the amount of memory used to provide the address space bridge is minimized. Further, in one embodiment of the present invention, the amount of memory can be further reduced by compressing the routine fragments within the “.asb”, and restoring the routine fragments just before program execution. The copying of routine fragments from the “.asb” section continues until all necessary routine fragments within the located “.asb” section are provided in memory (“Yes” branch of decision block 718). Once all of the necessary routine fragments have been copied, any relocation entries are processed (step 720). Following this, the initialization of the address space bridge is complete, step 722.

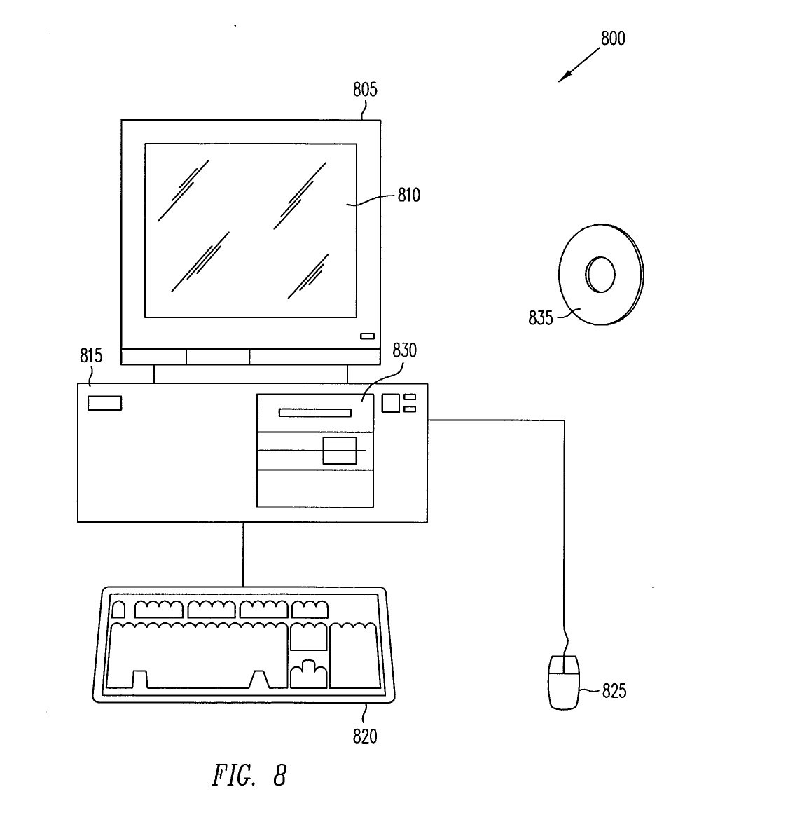

FIG. 8 shows a computer system 800 which can be used to carry out the steps shown and described in FIG. 1, FIG. 4, and FIG. 7, and store results of the same. Computer system 800 includes a display 805, a screen 810, a computer housing 815, a keyboard 820, and a mouse 825. Computer housing 815 includes a CD-ROM drive 830, a processor (not shown), system memory (not shown), storage subsystem (not shown), system bus (not shown), and network interface (not shown). Computer housing 815 can house circuitry that implements embodiments of the invention and data to be used by the same. CD-ROM drive 830, system memory, and the storage subsystem can be utilized to store and retrieve software incorporating computer code that implements embodiments of the invention. For example, CD-ROM drive 830 can utilize, store, and retrieve such computer code on a CD-ROM 835. Although CD-ROM 830 is shown as an exemplary computer readable storage medium, other computer readable storage media including floppy disk, tape, flash memory, system memory and hard drive can be utilized. Additionally, a data signal embodied in a network can be used as the computer readable storage medium.

Although the present invention has been described in connection with several embodiments, the invention is not intended to be limited to the specific forms set forth herein. On the contrary, it is intended to cover such alternatives, modifications, and equivalents as can be reasonably included within the spirit and scope of the invention as defined by the appended claims.

What is claimed is:

1. A method for optimizing an object file, comprising:
simulating execution of said object file, wherein said object file includes a control transfer instruction having an undefined target; and
modifying said object file to include an address space bridge section, wherein said address space bridge section is configured to define said undefined target.

2. The method of claim 1, wherein said address space bridge section comprises:
an original address space mapped for said object file.

3. The method of claim 2, wherein said original address space comprises:
a program routine from said object file, wherein said program routine defines said undefined target.

4. The method of claim 2, wherein said optimized address space comprises required program routines, wherein said required program routines are only those program routines which are necessary to define said undefined target.

5. The method of claim 2, wherein said original address space is compressed.

6. The method of claim 2, further comprising:
modifying said object file to include an initialization section, wherein said initialization section is configured to map said original address space in memory.

7. The method of claim 1, wherein said modifying said object file occurs only if said simulating execution of said object file is unable to define said undefined target.

8. An object file, comprising:
a control transfer instruction, said control transfer instruction having an undefined target; and
an address bridge section, wherein said address bridge section is configured to define said undefined target.

9. The object file of claim 8, wherein said address space bridge section comprises:
an original address space mapped for said object file.

10. The object file of claim 9, wherein said original address space comprises:
a program routine from said object file, wherein said program routine is configured to define said undefined target.

11. The object file of claim 9, wherein said original address space is compressed.

12. The object file of claim 9, further comprising:
an initialization section, wherein said initialization section is configured to map said original address space in a memory.

13. A compiler for optimizing an object file, comprising:
a module to simulate execution of said object file, wherein said object file includes a control transfer instruction having an undefined target; and
a module to modify said object file to include an address space bridge section, wherein said address space bridge section is configured to define said undefined target.

14. The compiler of claim 13, wherein said address space bridge section comprises:
an original address space mapped for said object file.

15. The compiler of claim 14, wherein said original address space comprises:
a program routine from said object file, wherein said program routine is configured to define said undefined target.

16. The compiler of claim 14, wherein said original address space is compressed.

17. The compiler of claim 14, further comprising:
a module to modify said object file to include an initialization section, wherein said initialization section is configured to map said original address space in memory.

18. The compiler of claim 13, wherein said module to modify said object file modifies said object file only if said module to simulate execution of said object file is unable to define said undefined target.

19. A method for defining a target for a control transfer instruction included in an optimized object file, comprising:
invoking an address space bridge when said optimized object file is executed.

20. The method of claim 19, wherein invoking said address space bridge comprises:
mapping an original address space in a memory, wherein said original address space defines said target.

21. The method of claim 20, further comprising:
un-compressing said original address space in a memory, if said original address space is compressed.

22. The method of claim 21, further comprising:
mapping a program routine in said original address space, wherein
said program routine is a program routine in said object file that includes said control transfer instruction, and
said program routine defines said target.

23. The method of claim 20, further comprising:
redirecting executing of said control transfer instruction to said original address space; and
reentering an optimized address space, wherein said optimized address space is a memory space where said optimized object file is mapped.

24. A compiler for optimizing an object file, comprising:
means for simulating execution of said object file, wherein said object file includes a control transfer instruction having an undefined target; and
means for modifying said object file to include an address space bridge section, wherein said address space bridge section is configured to define said undefined target.

25. The compiler of claim 24, wherein said address space bridge section comprises:
an original address space mapped for said object file.

26. The compiler of claim 25, wherein said original address space comprises:
a program routine from said object file, wherein said program routine is configured to define said undefined target.

27. The compiler of claim 25, wherein said original address space is compressed.

28. The compiler of claim 25, further comprising:
means for modifying said object file to include an initialization section, wherein said initialization section is configured to map said original address space in memory.

29. The compiler of claim 24, wherein said means for modifying said object file occurs only if said means for simulating execution of said object file is unable to define said undefined target.

30. A computer program product encoded in computer readable media, said computer program product comprising:
a first set of instructions, executable on a computer system, configured to simulate execution of an object file, wherein said object file includes a control transfer instruction having an undefined target; and
a second set of instructions, executable on said computer system, configured to modify said object file to include an address space bridge section, wherein said address space bridge section is configured to define said undefined target.

31. The computer system of claim 30, wherein said second set of instructions are executed only if said first set of instructions are unable to define said undefined target

32. The computer system of claim 30, wherein said computer program product further comprises:
a third set of instructions, executable on a computer system, configured to store an original address space of said object file, wherein said original address space defines said undefined target;
a fourth set of instructions, executable on a computer system, configured to compress said original address space to define a compressed address space; and
a fifth set of instructions, executable on a computer system, configured to modify said object file to include said compressed address space.

33. The computer system of claim 31, further comprising:
a sixth set of instructions, executable on a computer system, configured to modify said object file to include an initialization section, wherein said initialization section is configured to map said original address space in memory.
